(19) United States
(12) Patent Application Publication
(10) Pub. No.: US 2026/0023677 A1
(43) Pub. Date: Jan. 22, 2026

(54) AUTOMATED FIRMWARE DEBUGGING SYSTEM

(71) Applicant: Aivres Systems Inc., San Jose, CA (US)

(72) Inventor: Tzu Chi TENG, Taipei (TW)

(21) Appl. No.: 19/322,095

(22) Filed: Sep. 8, 2025

(51) Int. Cl. G06F 11/362; G06F 9/4401

(52) U.S. Cl. CPC G06F 11/366; G06F 9/4401

(57) ABSTRACT

A non-intrusive debugging method for computing system firmware is disclosed. At firmware image build time, diagnostic library references are redirected to an enhanced diagnostic library without modifying module source code. At compile time, diagnostic macros expand into calls to an enhanced diagnostic function that automatically injects a source-line identifier and an ever-increasing per-call-site counter. The enhanced function generates structured diagnostic records that are emitted through output interfaces selected according to the current boot phase, including deferred caching in initialization, external transmission in driver execution, and runtime-safe emission after virtual addressing. The structured records are preserved across phases to form a continuous diagnostic stream. Developer tools parse the stream to hyperlink logs to source code and visualize execution, while machine-learned models derive diagnostic fingerprints, identify known failure modes, and suggest root causes and fixes.

### TECHNICAL FIELD

The present disclosure relates generally to debugging of computing system firmware, and more particularly to non-intrusive techniques for capturing structured diagnostic records across multiple firmware boot phases and integrating the diagnostic data with developer-side analysis platforms and artificial intelligence models.

### BACKGROUND

As computing systems have grown in complexity, firmware has evolved from simple BIOS implementations to standardized Unified Extensible Firmware Interface (UEFI) architectures. Modern firmware executes a sequence of boot phases—including initialization, driver execution, and runtime—that collectively prepare hardware and software resources for an operating system. Debugging across these multiple phases remains a critical but challenging task.

Early debugging techniques relied on intrusive methods such as POST codes, raw serial messages, or hardware probes. These approaches produced unstructured and inconsistent diagnostic output, often requiring significant manual expertise to interpret. While UEFI frameworks such as EDK II introduced standardized diagnostic macros and libraries, shortcomings remain. Different firmware modules may depend on different diagnostic library families, leading to inconsistent log formats. Moreover, diagnostic records are still typically plain-text streams lacking source-level identifiers, function context, or ordering information, making automated log analysis difficult.

Accordingly, there is a need for a non-intrusive firmware debugging framework that avoids modifying firmware source code, generates structured diagnostic records across all boot phases, preserves continuity despite hardware constraints, and integrates with developer tools and machine-learned analysis to provide actionable insights.

### SUMMARY

A system of one or more computers can be configured to perform particular operations by virtue of software, firmware, hardware, or any combination thereof that, in operation, causes the system to perform the actions. One or more computer programs can likewise be configured to perform particular operations by including instructions that, when executed by data-processing apparatus, cause the apparatus to perform the actions.

In one general aspect, a computer-implemented method includes redirecting, at firmware image build time, diagnostic headers and diagnostic libraries referenced by firmware modules (that are built or linked into the firmware image) from default diagnostic libraries to an enhanced diagnostic library that exposes an enhanced diagnostic function. The method also includes receiving, during a firmware boot sequence of the computing system, a diagnostic invocation from one of the firmware modules via a diagnostic macro; expanding, at compile time of the firmware image, the diagnostic macro to call the enhanced diagnostic function that injects a source-line identifier and a monotonic per-call-site counter; generating, using the expanded diagnostic macro, a structured diagnostic record that includes at least the source-line identifier and the monotonic per-call-site counter followed by diagnostic information; and emitting the structured diagnostic record through an output interface selected according to a boot phase of the firmware boot sequence. Other embodiments of this aspect include corresponding computer systems, apparatus, and computer programs recorded on one or more computer-storage devices, each configured to perform the actions of the method.

Implementations may include one or more of the following features. The firmware boot sequence can include a plurality of boot phases, including at least an initialization phase, a driver-execution phase, and a runtime phase. Emitting the structured diagnostic record can include, in the initialization phase, appending the record to a temporary buffer associated with a processor of the computing system and deferring transmission until a later boot phase in which stable memory or I/O resources are available. Emitting the structured diagnostic record can further include, in the driver-execution (DXE) phase, transmitting the record from the firmware to an external debugging environment over at least one of a serial interface, a console output, or a debug-port interface. In the runtime phase, after the computing system has enabled virtual addressing, emitting can include updating internal pointers of the enhanced diagnostic function using the virtual addressing so that the record is transmitted through a runtime-safe output interface without interruption. A plurality of structured diagnostic records generated in the initialization, driver-execution, and runtime phases can be preserved and made available together so that they collectively form a continuous diagnostic stream across the firmware boot sequence. Redirecting at firmware image build time can include overriding diagnostic headers and diagnostic libraries from multiple different diagnostic-library families with the enhanced diagnostic library, where a first subset of the firmware modules are configured to reference a first diagnostic-library family and a second subset of firmware modules are configured to reference a second diagnostic-library family, and where the overriding ensures that diagnostic invocations in all firmware modules are routed to the enhanced diagnostic function. The enhanced diagnostic library can expose entry points compatible with each substituted diagnostic-library family and forward diagnostic invocations to the enhanced diagnostic function so that structured diagnostic records are produced consistently across different firmware modules. Generating the structured diagnostic record using the expanded macro can include formatting the record based on a measurement of available stack space, including computing a stack-pressure level from the measured space and dynamically switching the record format to reduce cache usage when the stack-pressure level exceeds a threshold. The method can further include providing the structured diagnostic record to an integrated development environment (IDE) running on a developer host, where the IDE parses a plurality of structured diagnostic records and hyperlinks them to corresponding source files and line numbers. The method can also include extracting a diagnostic fingerprint of a system failure or warning from a plurality of structured diagnostic records generated across the firmware boot sequence and generating a label for the diagnostic fingerprint that includes a root cause and a fix. The method can further include receiving a diagnosis request that includes a plurality of structured diagnostic records corresponding to an observed system failure; applying a trained machine-learning model to extract the diagnostic fingerprint from those records; identifying a matching diagnostic fingerprint previously labeled with the root cause and the fix; and providing the root cause and the fix in response to the diagnosis request. The trained machine-learning model can include a graph-based model that captures causal relationships among the plurality of structured diagnostic records. Implementations of the described techniques may be realized in hardware, as a method or process, or on a non-transitory computer-readable medium.

In another general aspect, a computing system is configured to: redirect, at firmware image build time, diagnostic headers and diagnostic libraries referenced by firmware modules from default diagnostic libraries to an enhanced diagnostic library that exposes an enhanced diagnostic function; receive, during a firmware boot sequence of the computing system, a diagnostic invocation from a firmware module via a diagnostic macro; expand, at compile time of the firmware image, the diagnostic macro to call the enhanced diagnostic function that injects a source-line identifier and a monotonic per-call-site counter; generate, using the expanded diagnostic macro, a structured diagnostic record that includes at least the source-line identifier and the monotonic per-call-site counter followed by diagnostic information; and emit the structured diagnostic record through an output interface selected according to a boot phase of the firmware boot sequence. Other embodiments of this aspect include corresponding computer systems, apparatus, and computer programs recorded on one or more computer-storage devices, each configured to perform the actions of the method.

In a further aspect, a non-transitory computer-readable storage medium storing firmware instructions includes instructions to: redirect, at firmware image build time, diagnostic headers and diagnostic libraries referenced by firmware modules from default diagnostic libraries to an enhanced diagnostic library that exposes an enhanced diagnostic function; receive, during a firmware boot sequence of the computing system, a diagnostic invocation from a firmware module via a diagnostic macro; expand, at compile time of the firmware image, the diagnostic macro to call the enhanced diagnostic function that injects a source-line identifier and a monotonic per-call-site counter; generate, using the expanded diagnostic macro, a structured diagnostic record that includes at least the source-line identifier and the monotonic per-call-site counter followed by diagnostic information; and emit the structured diagnostic record through an output interface selected according to a boot phase of the firmware boot sequence. Other embodiments of this aspect include corresponding computer systems, apparatus, and computer programs recorded on one or more computer-storage devices, each configured to perform the actions of the method.

### BRIEF DESCRIPTION OF THE DRAWINGS

Certain features of various embodiments of the present technology are set forth with particularity in the appended claims. A better understanding of the features and advantages of the technology will be obtained by reference to the following detailed description that sets forth illustrative embodiments, in which the principles of the disclosure are utilized, and the accompanying drawings of which:

FIG. 1 illustrates a toolchain and run-time flow for producing and using a firmware image with enhanced diagnostics, in accordance with some embodiments.

FIG. 2A illustrates a sample non-intrusive debugging enhancement for a firmware image, facilitating detection and analysis of failures in firmware booting process, in accordance with some embodiments.

FIG. 2B illustrates a sample enhanced diagnostic macro for a firmware image, in accordance with some embodiments.

FIG. 3 illustrates a sample mixed override architecture for a firmware image construction using hybrid libraries, in accordance with some embodiments.

FIG. 4A illustrates a sample firmware booting process, in accordance with some embodiments.

FIG. 4B illustrates a sample hierarchical logging mechanism for a firmware booting process involving multiple booting phrases, in accordance with some embodiments.

FIG. 5 illustrates a memory-aware diagnostic logging during the firmware initializing phase based on stack availability, in accordance with some embodiments.

FIG. 6 illustrates an Artificial Intelligence (AI)-powered diagnostic system using the non-intrusive enhanced debugging architecture, in accordance with some embodiments.

FIG. 7 illustrates an example method of non-intrusive firmware debugging during system boot, according to one example embodiment.

FIG. 8 illustrates a block diagram of an example computer system in which various of the embodiments described herein may be implemented.

### DETAILED DESCRIPTION OF EMBODIMENTS

In the following description, certain specific details are set forth in order to provide a thorough understanding of various embodiments of the disclosure. However, one skilled in the art will understand that the disclosure may be practiced without these details. Moreover, while various embodiments of the disclosure are disclosed herein, many adaptations and modifications may be made within the scope of the disclosure in accordance with the common general knowledge of those skilled in this art. Such modifications include the substitution of known equivalents for any aspect of the disclosure in order to achieve the same result in substantially the same way.

Unless the context requires otherwise, throughout the present specification and claims, the word “comprise” and variations thereof, such as, “comprises” and “comprising” are to be construed in an open, inclusive sense, that is as “including, but not limited to.” Recitation of numeric ranges of values throughout the specification is intended to serve as a shorthand notation of referring individually to each separate value falling within the range inclusive of the values defining the range, and each separate value is incorporated in the specification as it were individually recited herein. Additionally, the singular forms “a,” “an” and “the” include plural referents unless the context clearly dictates otherwise.

Reference throughout this specification to “one embodiment” or “an embodiment” means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment, but may be in some instances. Furthermore, the particular features, structures, or characteristics may be combined in any suitable manner in one or more embodiments.

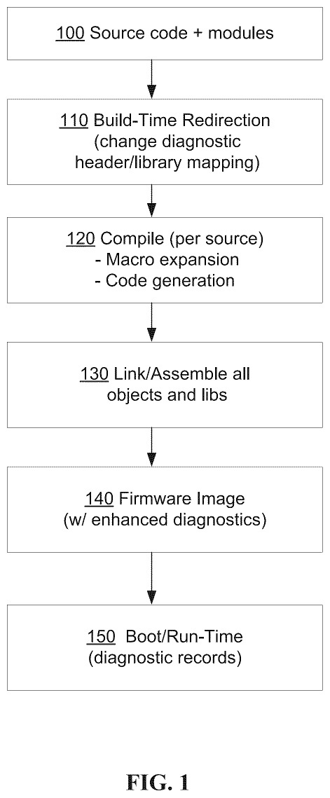

FIG. 1 illustrates a toolchain and run-time flow for producing and using a firmware image with enhanced diagnostics, in accordance with some embodiments. A firmware image in this context refers to a low-level executable code that a computing system's processor loads from non-volatile storage at power-on to initialize hardware, configure memory controllers and buses, load device drivers, select a boot device, and later provide runtime services under operating-system control. In computing technologies, the firmware executes before the OS and under tight resource and timing constraints, and diagnosing failures in the firmware boot sequence often relies on diagnostic logs. However, traditional logging often uses ad-hoc serial text or POST codes that lack stable identifiers, call-site context, or reliable ordering, which makes automated analysis and rapid root-cause isolation difficult.

The flowchart in FIG. 1 shows an example non-intrusive debugging enhancement architecture for producing and using a firmware image. At 100, source code for multiple firmware modules and libraries is provided to the firmware build system, which system selects headers and libraries, applies build options, invokes preprocessing and compilation, and performs link/assembly to generate the firmware image. These modules implement initialization, driver execution, and runtime services that will ultimately be packaged into the firmware image. In practice, a computing system firmware may be assembled from heterogeneous modules: for example, a memory-initialization module in the Pre-EFI Initialization (PEI) phase, a PCI bus enumerator, NVMe/USB/network/graphics drivers in the Driver Execution (DXE) phase, runtime services for variables and time after Unified Extensible Firmware Interface (UEFI) handoff, and protected handlers in System Management Mode (SMM). Some modules may be constructed and customized in-house, others may arrive as silicon-vendor reference code, independent BIOS/firmware-vendor packages, peripheral-vendor drivers, or open-source EFI Development Kit II (EDK II) components. Consequently, different modules may depend on different diagnostic library families (e.g., a vendor-specific implementation versus the standard UEFI/EDK II implementation). In existing systems, the build and diagnostic frameworks generally do not account for the coexistence of the different logging mechanisms across these different library families, so the final firmware boot logs are a patchwork of formats and severities with inconsistent fields and ordering. This non-uniformity defeats automated parsing and indexing, impedes correlation of events across phases, and complicates timeline reconstruction, making machine-assisted triage and root-cause analysis unreliable and forcing labor-intensive manual review.

The subsequent steps shown in FIG. 1 are designed to normalize those heterogeneous logging mechanisms by redirecting all diagnostic library families to a single enhanced diagnostic path, yielding uniform, structured records suitable for automated analysis. In some embodiments, at 110, a build-time redirection step changes the diagnostic header and library mapping used by the build. The build configuration enumerates each diagnostic library family used in the platform—across initialization, driver-execution, system-management, and runtime variants—and substitutes the corresponding enhanced headers and libraries, so that a module referencing a different library family is compiled against the enhanced interface. This redirection occurs entirely in build configuration and does not require edits to any module's source code, which is why the approach is non-intrusive. At 130 (link/assembly), library bindings for each family are also mapped to the enhanced libraries so that prebuilt modules or modules not recompiled in the workspace still resolve their diagnostic symbols to the same enhanced implementation.

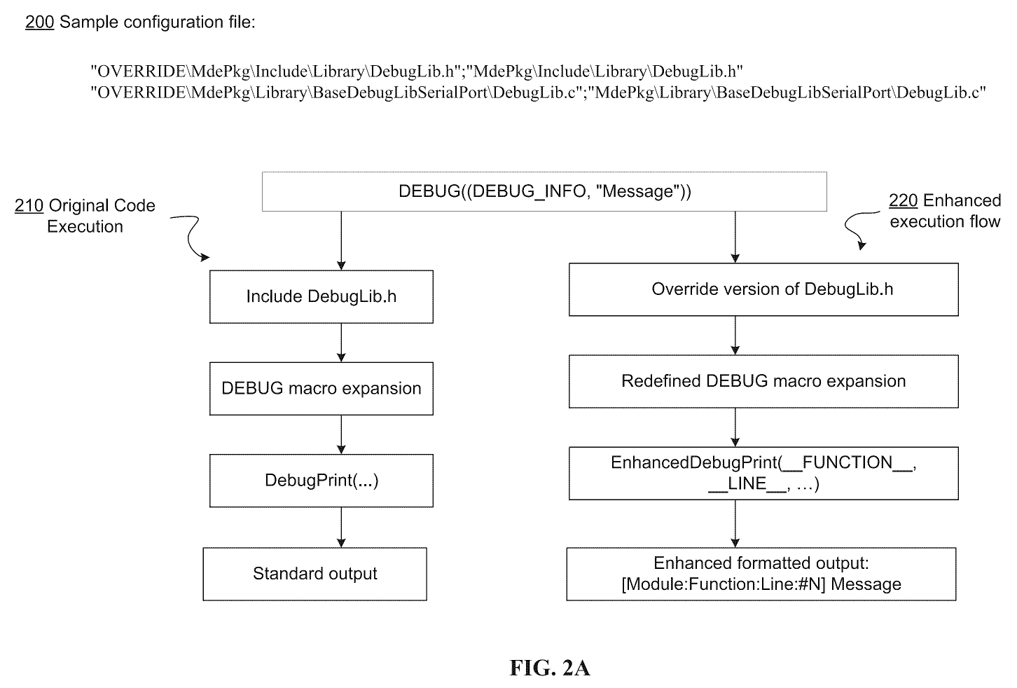

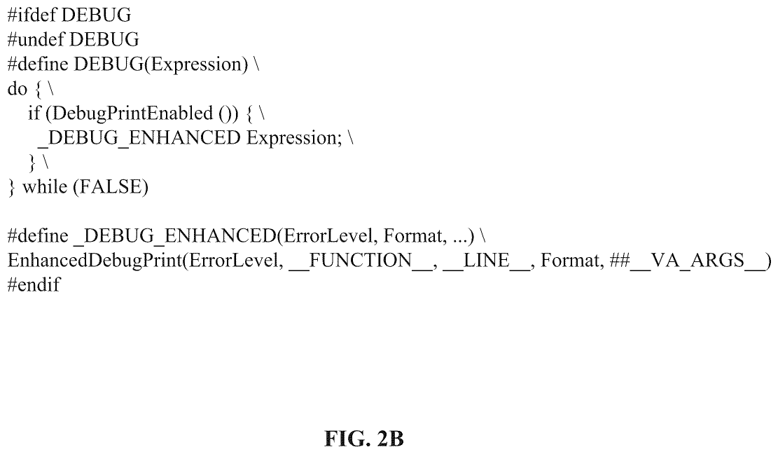

At 120, each source file is compiled. During compilation, the preprocessor expands the existing diagnostic macro in the substituted header so that a legacy call is rewritten into a call to an enhanced diagnostic function. In some embodiments, the compiler automatically injects at least a function identifier and source-line identifier, and the enhanced function maintains an ever-increasing per-call-site counter (more details in FIGS. 2A and 2B). To bridge differences between library families, the enhanced library exposes entry points compatible with each family's diagnostic APIs and internally forward those calls into the same enhanced function, ensuring that modules compiled against different families produce the same structured record format. These injected fields and compatible entry points convert otherwise free-form messages into uniform, machine-parsable diagnostic records without touching the module that issued the original macro.

At 130, the linker assembles object files and libraries into firmware binaries and resolves diagnostic symbols for each diagnostic library family across all boot sub-phases to the corresponding enhanced libraries. This link-time binding captures modules that were not recompiled in the workspace or that invoke diagnostic entry points directly, ensuring their emissions are routed into the same enhanced path. The mapping prevents fallback to non-enhanced implementations and preserves module encapsulation because no source edits are required—the uniformity arises from symbol resolution at link/assembly.

At 140, the resulting firmware image includes the enhanced diagnostics. When installed on a target platform, it emits structured records that carry consistent, machine-parseable fields such as module, function, line, and a per-call-site counter, enabling deterministic ordering and call-site correlation even when multiple CPUs interleave events.

At 150, during boot and runtime, the firmware produces diagnostic records. The output interface is selected according to the current boot sub-phase. For example, in early initialization, records may be buffered and flushed later when memory or I/O becomes available; in driver execution, the records may be transmitted immediately over serial, console, or a debug port to an external analysis host; and in runtime, after the computing system enables virtual addressing, internal pointers of the enhanced diagnostic function are updated so emission continues without interruption. The richer, phase-safe records improve failure detection and resolution by allowing automated correlation, fast navigation back to the originating source line, and reliable reconstruction of execution timelines across the entire firmware boot sequence.

For highlighting the technical steps in the workflow of FIG. 1, steps 110, 120, and 130 operate as a single toolchain pipeline that achieves normalization without altering module sources. At 110 (build), the firmware build system selects inputs and options: it rewrites header and library selection in the build configuration so each module sees the enhanced diagnostic header and so diagnostic library references from all library families are mapped to enhanced implementations. At 120 (compile), example C/C++ preprocessor and compiler translate each code unit; because the substituted header is in effect, existing diagnostic macros expand into calls to the enhanced diagnostic function and the resulting object files contain relocations that reference that symbol together with injected function/line metadata. At 130 (link/assemble), the linker resolves those relocations and any remaining diagnostic entry points to the enhanced libraries, then the assembler/packager lays out PEI/DXE/SMM/Runtime binaries into firmware volumes. This division of labor is what makes the approach non-intrusive: build controls which headers/libraries are seen, compile performs the macro rewrite where sources are available, and link/assemble guarantees that even prebuilt or differently configured objects bind to the same enhanced path, yielding uniform, structured diagnostics in the final image.

FIG. 2A illustrates a sample non-intrusive debugging enhancement for a firmware image, facilitating detection and analysis of failures in firmware booting process, in accordance with some embodiments. In particular, a build-time override (using an override configuration file) drives macro remapping at compile time to produce structured diagnostics. The sample configuration file 200 shows entries that redirect both a diagnostic header (.h file) and an implementation file (.c file) within a first diagnostic-library family to enhanced counterparts. Similar entries may be added for other diagnostic-library families used by the platform so that, at firmware image build time, any module that would otherwise include a default diagnostic header or link against a default diagnostic library instead sees the enhanced header and links against the enhanced library. In some embodiments, the configuration file 200 is an override file (e.g., an override.cif) that declaratively specifies file-replacement rules supported by the build environment, enabling transparent substitution without editing module sources.

With the build-time override, the execution of a debug macro in a module of the firmware source code changes, as shown in the flow chart in FIG. 2A. To establish a baseline for comparison, the left swim-lane labeled 210 (Original code execution) depicts the conventional path. A module includes the default DebugLib.h, the DEBUG( . . . ) macro expands to a library call such as DebugPrint( . . . ), and the library emits a plain, device-specific text stream as standard output. Because different diagnostic-library families format differently, logs produced this way are non-uniform and difficult to correlate automatically.

By contrast, the right swim-lane labeled 220 (Enhanced execution flow) shows the path after the build-time redirection in 200. During compilation, the module still writes DEBUG((DEBUG_INFO, “Message”)), but the substituted header causes the compiler to expand that macro into a call to an enhanced diagnostic function, e.g., EnhancedDebugPrint(ErrorLevel, _FUNCTION_, _LINE_, . . . ). At run time (RunTime) the enhanced function constructs a compact, schema-constrained record, for example, [Module:Function:Line:#N] Message, where “Module” identifies the firmware module, “Function” and “Line” are injected by the compiler via _FUNCTION_ and _LINE_, and “#N” is a monotonic per-call-site counter indicating how many times that exact source line has fired. To achieve the “non-intrusiveness” of the design, the per-call-site counter is realized without editing existing source code. In one embodiment the macro expansion materializes the per-call-site counter that is atomically incremented (e.g., via InterlockedIncrement) immediately before invoking EnhancedDebugPrint. In another embodiment, the enhanced library maintains a small lock-free counter table keyed by a stable site identifier derived from (Module, Function, Line) or a compact hash. Either approach preserves timing characteristics while enabling precise ordering and rarity ranking when multiple CPUs interleave messages.

In this embodiment, the per-call-site counter (“#N”) carries information that ordinary text logs cannot. Because the counter is monotonic for each specific source line, it provides a stable local timeline even when global timestamps are noisy or records from different CPUs interleave. That allows tools to reconstruct the exact order of hits at a given call site, detect gaps that imply dropped records, and measure inter-arrival distance to spot rate shifts. A rapidly increasing counter on one line can reveal tight loops, livelocks, or hot paths, while a rarely incrementing counter highlights one-off edge cases worth inspection. When the same message text appears at multiple locations, the trio of Module:Function:Line plus the counter disambiguates them and allows deduplication without symbol servers. The counter also supplies a numeric feature for downstream analytics: sliding-window variance and burstiness can be computed per site, thresholds can trigger sampling or throttling, and, in the AI embodiment, the counter trajectory becomes part of the fingerprint that distinguishes failure modes across boots and phases.

FIG. 2B illustrates a sample enhanced diagnostic macro for a firmware image, in accordance with some embodiments. As shown, in the sample overridden file, the existing DEBUG macro is undefined and redefined so that DEBUG(Expression) expands, under the DebugPrintEnabled( ) guard, into a helper macro _DEBUG_ENHANCED. The helper macro preserves the original error level and variadic format arguments and expands to EnhancedDebugPrint(ErrorLevel, _FUNCTION_, _LINE_, Format, ##_VA_ARGS_). As described with FIG. 2A, this compile-time remapping makes legacy DEBUG( . . . ) calls transparently invoke an enhanced diagnostic function that injects structured information, such as the calling function and source line, an ever-increasing per-call-site counter, resulting an example structured record [Module:Function:Line:#N] Message. Because the macro change resides solely in the header selected at build time, no firmware module source code is edited, thereby providing the non-intrusive redirection, compile-time expansion, structured record generation, and phase-aware emission.

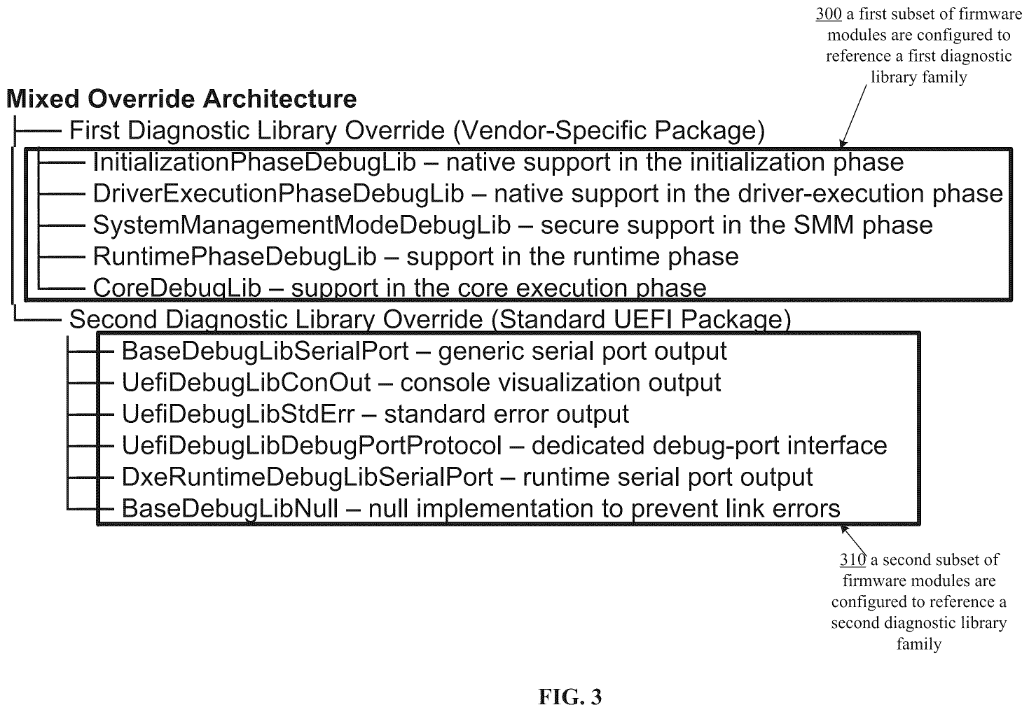

FIG. 3 illustrates a mixed override architecture for constructing a firmware image from heterogeneous libraries, in accordance with some embodiments. In many platforms, modules are not all built against the same diagnostic stack: some target a vendor-specific, phase-scoped library family (e.g., Initialization, Driver-Execution, System-Management-Mode, Runtime, Core), while others target a standard UEFI/EDK-style family that provides console/serial/debug-port back ends. This heterogeneity arises because products combine in-house code with silicon-vendor reference packages, independent BIOS/firmware-vendor components, and peripheral-vendor drivers, including prebuilt binaries.

In the example of FIG. 3, two sets of modules are shown. At 300, a first subset of firmware modules reference the first (vendor-specific) diagnostic library family; representative producers of diagnostic output include a memory-initialization PEIM, a CPU bring-up PEIM, SMM handlers for power or thermal events, and runtime variable/time services. At 310, a second subset of firmware modules reference the second (standard UEFI) diagnostic library family; representative producers include a PCI bus enumerator, NVMe/USB/network/graphics drivers, and platform table generators.

To achieve complete and uniform coverage, the mixed override illustrated in FIG. 3 enumerates each family and, at firmware image build time, substitutes enhanced headers and libraries for both, so modules bound to either family compile or link against enhanced counterparts. The enhanced libraries expose entry points compatible with the originals and forward diagnostic invocations to a single enhanced diagnostic function; at link/assembly, remaining symbols—including null or prebuilt stubs—are resolved to the enhanced libraries. As a result, all modules, regardless of origin or library family, emit the same structured diagnostics suitable for automated analysis.

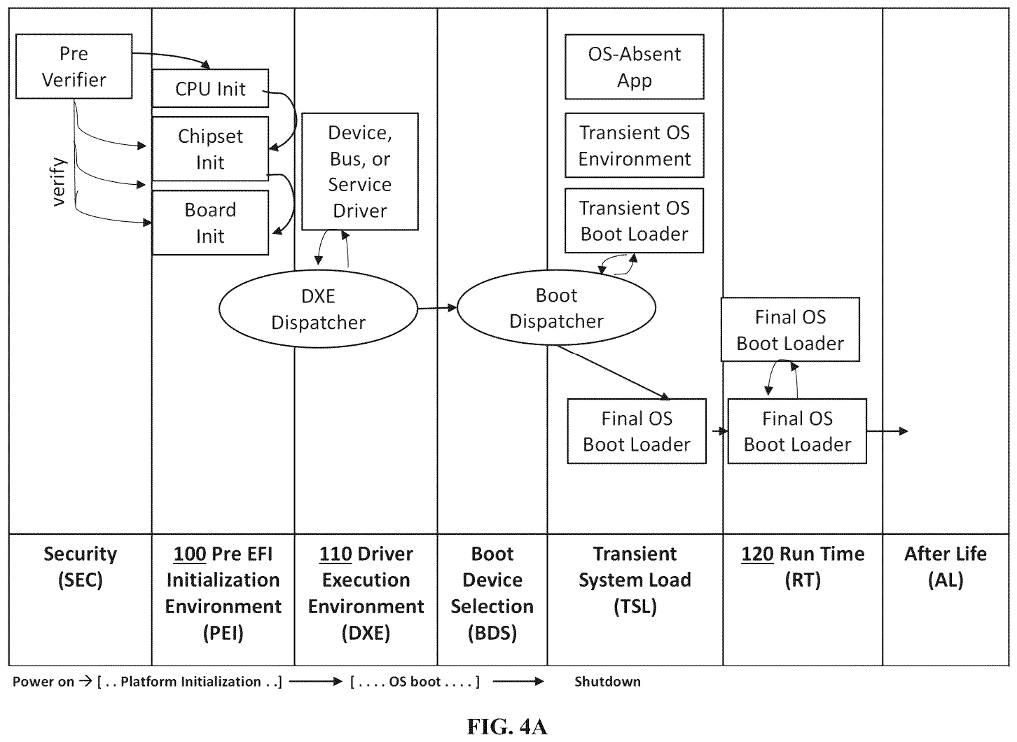

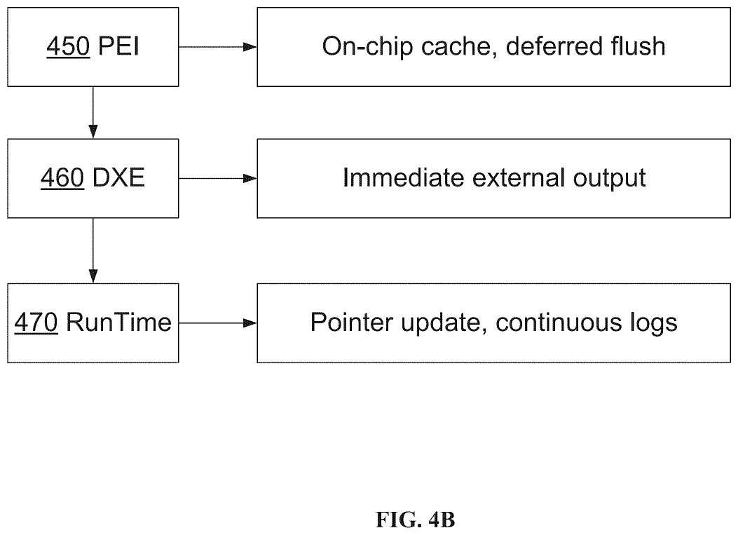

FIG. 4A illustrates a sample firmware booting process, in accordance with some embodiments. The flow in FIG. 4A proceeds left to right. The process begins in the Security (SEC) phase, where a Pre Verifier authenticates the image and minimal bring-up occurs through CPU Init, Chipset Init, and Board Init. These steps execute from on-chip resources and ROM, with no off-chip memory or consoles available.

After SEC, the platform enters Pre-EFI Initialization (PEI) 100. PEI discovers permanent memory but, until DRAM is fully trained, only on-chip cache (e.g., L1/L2/L3) or temporary buffer of the processor is reliably available for scratch storage. Considering the available hardware resources, the enhanced diagnostic architecture described in FIGS. 1-3 (referred to as “enhanced diagnostic engine” for simplicity) may append each structured record to a small cache-resident ring buffer and defers transmission. This design avoids timing perturbations on memory and I/O buses that are not yet configured, prevents deadlocks caused by early device accesses, and still preserves a complete record of early events. PEI also constructs a hand-off blocks (HOB) list that passes hardware state forward.

The system then transitions to the Driver Execution (DXE) phase 110. For instance, a DXE Dispatcher consumes the HOB list and orchestrates the loading of Device, Bus, or Service Driver modules. The DXE Dispatcher exposes UEFI Boot Services and DXE Services; DRAM is now available, and drivers bring up serial controllers, graphics consoles, and debug-port interfaces. With stable memory and I/O in place, the enhanced diagnostic engine may first flush the PEI cache buffer to preserve ordering, then transmit records immediately to an external debugging environment over serial, console, or a debug-port interface. Immediate emission in DXE 110 provides real-time observability while leveraging abundant memory to retain structured logs for post-mortem analysis.

Next, Boot Device Selection (BDS) uses a Boot Dispatcher to implement boot policy. Depending on configuration, the enhanced diagnostic engine may enter a Transient System Load (TSL) that runs an OS-Absent App, a Transient OS Environment, or a Transient OS Boot Loader before handing control to a Final OS Boot Loader. Throughout BDS/TSL the enhanced diagnostic engine continues to emit the same structured format; the per-call-site counter maintains local ordering when multiple CPUs interleave messages, and continuity is preserved because the DXE transports remain active.

After handoff, the system enters RunTime (RT) 120, where UEFI Runtime Services persist under operating-system (OS) control. When the OS enables virtual addressing and issues the virtual-map event, the enhanced diagnostic engine updates internal pointers (e.g., buffer bases and function trampolines) into the OS virtual address space so that logging continues through a runtime-safe output interface without interruption. This adaptation is implemented because physical addresses used during PEI/DXE are no longer valid under the OS's Memory Management Unit (MMU) policy; without pointer updates, diagnostic emission would fail and the stream would be fragmented.

In FIG. 4A, an optional After Life (AL) window may follow shutdown activities for tasks such as preserving final logs or scheduling wake events. The engine can persist a summary or final watermark so that the next boot can detect incomplete sequences.

In conclusion, FIG. 4A demonstrates why it is necessary to implement different emission behaviors across the different sub-phases and how those behaviors arise from the constraints of the existing firmware stack. For instance, in PEI 100 there is no DRAM or I/O, so records are cached on-chip and deferred; in DXE 110 memory and devices are available, so records are transmitted immediately to external interfaces; in RT 120 the OS switches to virtual addressing, so the engine updates pointers and continues emission via a runtime-safe path. Because every record retains the same schema and per-call-site counter, the system preserves and unifies diagnostics across PEI, DXE, and RT into a continuous stream that supports automated correlation, reliable timeline reconstruction, and faster root-cause analysis.

FIG. 4B illustrates a sample hierarchical logging mechanism for a firmware booting process involving multiple boot phases, in accordance with some embodiments. The left column in FIG. 4B lists the sample sub-phases of a booting process of a firmware image and the right column summarizes the transport (i.e., an output interface) selected in each sub-phase.

For example, in PEI 450, permanent memory and I/O are not yet available, so the enhanced diagnostic engine described above appends each structured record to an on-chip cache buffer and defers flushing. In one embodiment the buffer is a temporary buffer associated with the processor (e.g., L1, L2, L3 cache), which has a producer index advanced by an atomic operation to remain safe under early Symmetric Multiprocessing (SMP) bring-up (multiple CPUs may start executing initialization code nearly simultaneously); the flush is triggered at a phase-safe handoff, for example on entry to DXE when DRAM and a UART/debug port are initialized.

In DXE 460, UEFI Boot Services and drivers provide stable memory and external interfaces. The enhanced diagnostic engine described above transmits records immediately to an external debugging environment, selecting among serial, console, or a debug-port interface. Buffered PEI records are emitted first in order so that the resulting stream is continuous, after which DXE-generated records are streamed in real time. Because the producer API remains the same DEBUG( . . . ) macro, this upgrade from deferred caching to immediate output is non-intrusive to modules.

In RunTime 470, after the operating system enables virtual addressing, the enhanced diagnostic engine described above updates internal pointers (for example, buffer bases, protocol handles, and MMIO pointers) to their OS-visible virtual addresses and continues logging without interruption via a runtime-safe transport. This hierarchical behavior implements the phase-aware steps discussed in FIG. 4A: caching and deferral in initialization, immediate external transmission in driver execution, and pointer rebasing for continuous runtime logs. The result is a single, uniform diagnostic stream across phases that preserves ordering and enables automated correlation and reliable timeline reconstruction.

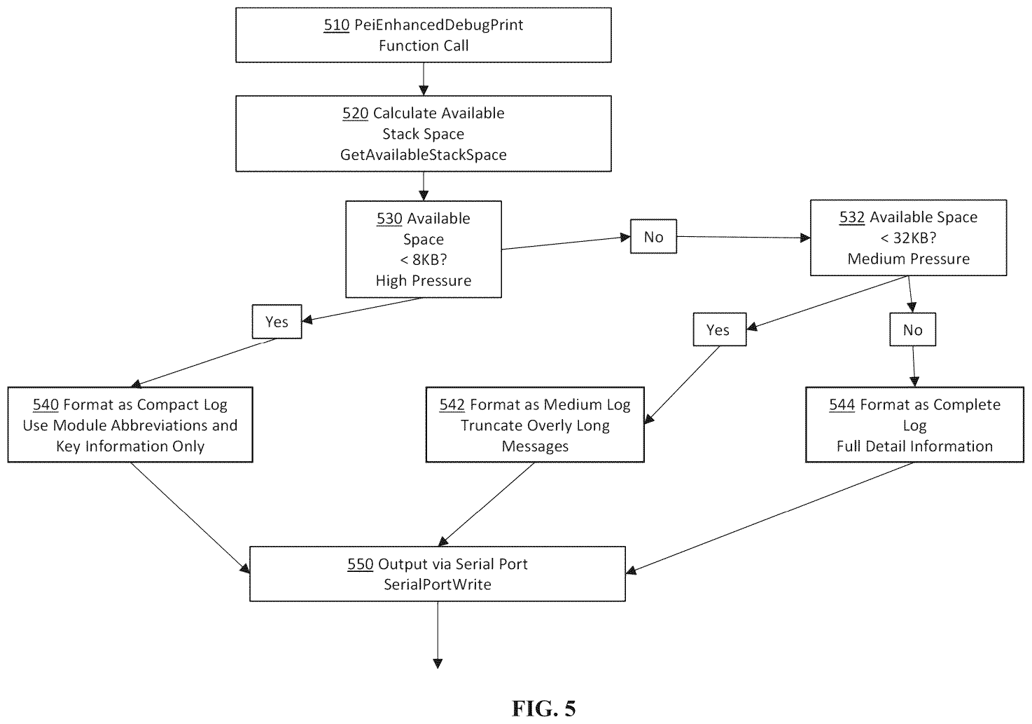

FIG. 5 illustrates a memory-aware diagnostic logging during the firmware initializing phase based on stack availability, in accordance with some embodiments. In practice, during the Pre-EFI Initialization (PEI) phase of the computing system booting process, the computing system does not yet have access to DRAM, and I/O devices such as UARTs or consoles are not initialized, as timing is sensitive in this stage.

To deal with this memory space constraint, the enhanced diagnostic engine dynamically formats each record based on a real-time measurement of available stack space. As shown in FIG. 5, a function call to the enhanced print routine (510) first invokes a measurement procedure (520) that calculates remaining stack space. The enhanced diagnostic engine then classifies the result into different pressure levels. If the measurement indicates high pressure (e.g., the remaining stack space is less than 8 KB available, 530), the record is output in a compact format (540) that uses abbreviations and preserves only key information (e.g., only logging the per-call-site counter along with the log message). If the measurement indicates medium pressure (e.g., the remaining stack space is less than 32 KB but greater than 8 KB, 532), the record is formatted as a medium log (542), truncating overly long messages while retaining critical fields (e.g., keeping the function identifier, line identifier, per-call-site counter, and the log message). If sufficient space is available, the engine produces a complete log (544) with full details such as module identifier, function identifier, line identifier, per-call-site counter values, and the log message. Regardless of format, the record is later transmitted through a designated output path, such as a serial port routine (550).

This memory-aware, adaptive formatting ensures that diagnostics are emitted without exhausting early boot resources. Even in severe stack pressure conditions, developers may still obtain usable logs, while preserving system stability. The technical effect is that firmware debugging becomes resilient in resource-starved phases, while still delivering a continuous diagnostic stream once records are flushed and joined with those from later phases.

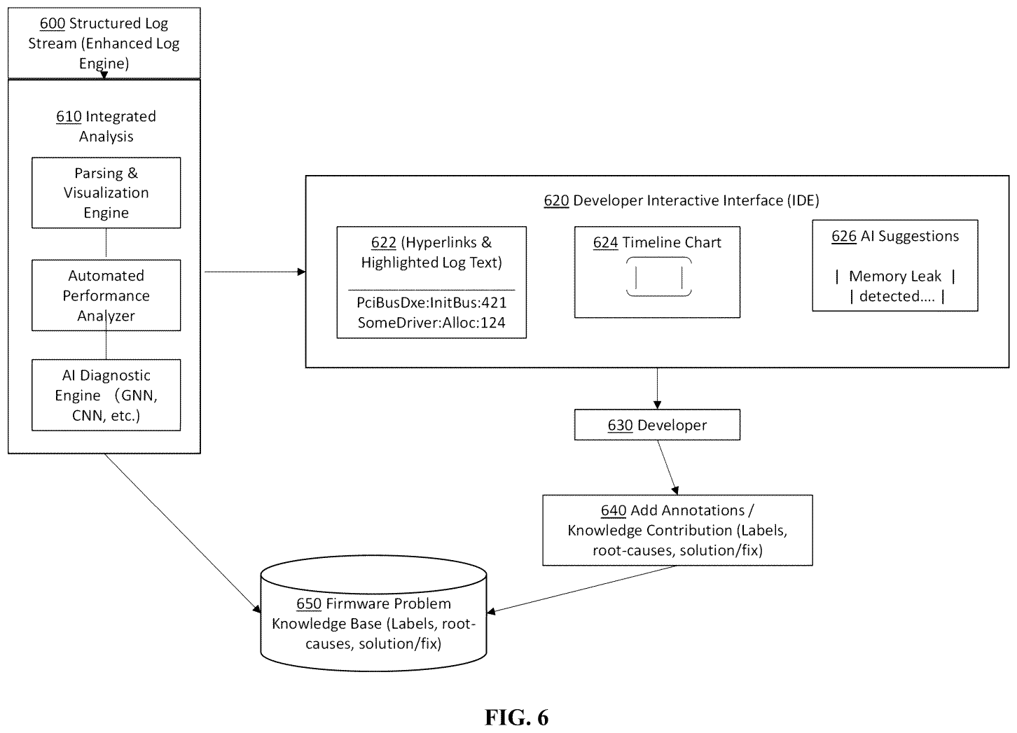

FIG. 6 illustrates an Artificial Intelligence (AI)-powered diagnostic system that consumes the non-intrusively produced structured logs and turns them into developer actions and machine-learned knowledge, in accordance with some embodiments. As shown, a structured log stream 600 is emitted by the enhanced diagnostic engine described earlier. Each record adheres to a schema that includes at least the module identifier, function identifier, source-line identifier, and a monotonic per-call-site counter, and may also include a timestamp, phase tag, severity, and optional key-value fields. Because the stream is uniform across PEI, DXE, and runtime, downstream tools can rely on stable fields and ordering to perform deterministic analysis.

In some embodiments, the stream 600 is fed into an integrated analysis layer 610 that hosts three cooperating components. The parsing-and-visualization engine of 610 treats each record as a rigid header and a free-form n body. For instance, the header [Module:Function:Line:#N] is resolved to an exact source location using build metadata, while the body is normalized with a hybrid natural-language pipeline. Deterministic recognizers capture firmware domain patterns such as PCI bus/device/function triplets, GUIDs, EFI/UEFI status codes, variables, protocol names, device paths, sizes, and addresses; a lightweight ML tagger extracts actions and arguments such as allocate/free, connect/disconnect, install/open protocol, and read/write variable. From these enriched records, 610 may also build an explicit boot graph whose nodes represent call sites and resources and whose edges capture relations—invokes, installs, opens, enumerates, depends-on—with per-edge phase, time, and local sequence ranges derived from the monotonic per-call-site counter. This graph may be latter rendered to the IDE 620 as an interactive view synchronized with the timeline, so selecting a spike in time highlights the active subgraph and selecting a node or path filters the corresponding log slices and navigates to source.

As another example, the automated performance analyzer inside 610 consumes the normalized fields and graph to compute per-call-site latencies, inter-arrival distances, and burstiness. Using timestamps and the local sequence counter to survive CPU interleaving, it maintains sliding-window statistics, moving averages, and variance; derives change-point and drift signals; and compares current runs with stored baselines to surface regressions. Heuristics and statistical tests mark stalls on critical paths, tight loops and livelocks, queue buildup behind hot resources, and jitter introduced by device initialization. Findings are emitted as structured events that the IDE 620 can later place on the timeline and cross-link back to the generating records and source lines.

As yet another example, the AI diagnostic engine of 610 generates higher-level patterns and fingerprints from both the record stream and the boot graph. In one embodiment, a graph model (for example, a graph neural network (GNN)) embeds call-site/resource nodes and dependency edges to capture causal structure across phases, while sequence or text models encode message orderings and semantics. The AI diagnostic engine may produce fingerprints that combine subgraph motifs, ordered call-site sequences, and temporal features derived from the per-call-site counter and timestamps. At inference time, these fingerprints may be used for retrieving nearest neighbors (for an observed debugging log pattern) from previously labeled cases, ranks candidate matches by structural and temporal similarity, and emits preliminary diagnoses—such as memory leaks from unmatched allocate/free paths, ordering hazards on protocol installations, or anomalous call patterns-ready for review in the IDE 620.

In some embodiments, results from 610 are surfaced in a developer interactive interface (IDE) 620. The IDE presents hyperlinks and highlighted log text 622; clicking an entry navigates directly to the corresponding source file and line by resolving the Module:Function:Line tuple to the project's indexed sources and revision. The IDE 620 may also render a timeline chart 624 that visualizes execution across cores and phases, using the per-call-site counter to disambiguate interleaved events, and supports zoom, filter by severity or module, hover-to-stack previews, and cross-selection that highlights the originating records. In addition, the IDE may also show AI suggestions 626, which are preliminary diagnostics produced by the analysis layer, e.g., suspected memory leaks, device-init ordering hazards, regressions relative to a baseline boot, and anomalous or potentially malicious call patterns inferred from graph motifs.

With the IDE 620, a developer 630 reviews the information and may accept, refine, or reject the AI suggestions 626. The IDE 620 enables the developer to author annotations 640 on the relevant record spans—labels, hypothesized root causes, and fixes or workarounds—and to link them to the exact call sites and counter ranges. These contributions are merged with the structured records and stored in a firmware problem knowledge base 650 together with derived fingerprints generated by the analysis layer 610. The fingerprints can encode, for example, an ordered sequence of call-site identifiers, a subgraph describing dependency edges and resource transitions, and statistical features such as variance of inter-arrival counts.

During a subsequent investigation or inference, a workflow may retrieve the structured records for a new failure and query the knowledge base 650. The integrated analysis 610 extracts a fingerprint from the new record set using the same pipeline and applies a trained machine-learning model to find the closest match among prior fingerprints. The graph-based component compares causal structure (e.g., nodes for call sites and resources, edges for happens-before, locking, and I/O dependencies), while temporal features derived from the per-call-site counter and timestamps align sequences that span different boots or CPU interleaving. When a match is identified, the system returns the associated label, root cause, and fix authored in annotations 640, and the IDE 620 presents them alongside the current logs 622/624/626. If no confident match exists, the developer 630 can annotate the new pattern, and the new fingerprint plus annotations are added to the knowledge base 650 to refine future inference.

The arrangement shown in FIG. 6 provides an end-to-end feedback loop: the enhanced engine supplies an enhanced and structured stream 600; the analysis engine 610 parses, visualizes, measures performance, and derives AI fingerprints; the IDE 620 turns those insights into actionable navigation and suggestions; the developer 630 contributes authoritative annotations 640; and the knowledge base 650 preserves labeled fingerprints for future diagnosis. This loop automates and accelerates triage and root-cause analysis and improves over time as more labeled cases accumulate, while remaining non-intrusive to the firmware code because all intelligence is built on the structured records produced by the enhanced diagnostic path.

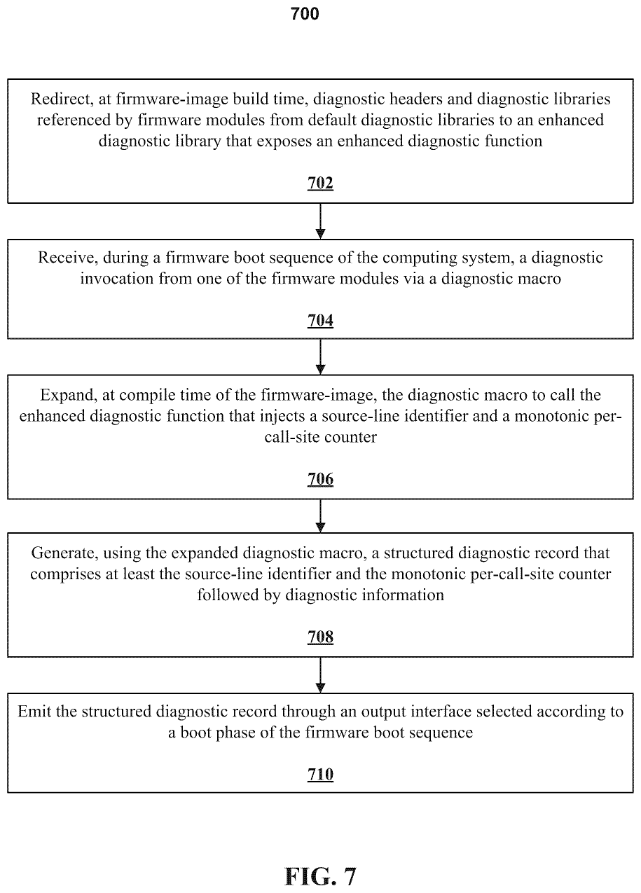

FIG. 7 is a flowchart of an example process 700. In some implementations, one or more blocks of FIG. 7 may be performed by a device.

As shown in FIG. 7, process 700 includes redirecting, at firmware image build time, diagnostic headers and diagnostic libraries referenced by modules from default diagnostic libraries to an enhanced diagnostic library that exposes an enhanced diagnostic function (block 702). Process 700 then includes receiving, during a firmware boot sequence of the computing system, a diagnostic invocation from a firmware module via a diagnostic macro (block 704). Next, the device expands, at compile time of the firmware image, the diagnostic macro to call the enhanced diagnostic function that injects a source-line identifier and a monotonic per-call-site counter (block 706). Using the expanded macro, the device generates a structured diagnostic record that includes at least the source-line identifier and the monotonic per-call-site counter followed by diagnostic information (block 708). Finally, the device emits the structured diagnostic record through an output interface selected according to a boot phase of the firmware boot sequence (block 710).

Process 700 may include additional implementations, individually or in combination with one another. In a first implementation, the firmware boot sequence includes a plurality of boot phases, including at least an initialization phase, a driver-execution phase, and a runtime phase. In a second implementation, the emitting step includes, in the initialization phase, appending the structured diagnostic record to a temporary buffer associated with a processor of the computing system and deferring transmission until a later boot phase in which stable memory or I/O resources are available. In a third implementation, the emitting step includes, in the driver-execution (DXE) phase, transmitting the structured diagnostic record from the firmware to an external debugging environment over at least one of a serial interface, a console output, or a debug-port interface. In a fourth implementation, the emitting step includes, in the runtime phase after the computing system has enabled virtual addressing, updating internal pointers of the enhanced diagnostic function using the virtual addressing so that the structured diagnostic record is transmitted through a runtime-safe output interface without interruption. In a fifth implementation, a plurality of structured diagnostic records generated in the initialization, driver-execution, and runtime phases are preserved and made available together so that they collectively form a continuous diagnostic stream across the firmware boot sequence.

In a sixth implementation, redirecting at firmware image build time includes overriding the diagnostic headers and diagnostic libraries from multiple different diagnostic library families with the enhanced diagnostic library, where a first subset of firmware modules are configured to reference a first diagnostic library family and a second subset of firmware modules are configured to reference a second diagnostic library family, and where the overriding ensures that diagnostic invocations in all firmware modules are routed to the enhanced diagnostic function. In a seventh implementation, the enhanced diagnostic library exposes entry points compatible with each substituted diagnostic library family and forwards diagnostic invocations to the enhanced diagnostic function so that structured diagnostic records are produced consistently across different firmware modules. In an eighth implementation, generating the structured diagnostic record using the expanded macro includes formatting the record based on a measurement of available stack space, including computing a stack-pressure level from the measured space and dynamically switching the record format to reduce cache usage when the stack-pressure level exceeds a threshold.

In a ninth implementation, process 700 further includes providing the structured diagnostic record to an integrated development environment (IDE) running on a developer host, where the IDE parses a plurality of structured diagnostic records and hyperlinks them to corresponding source files and line numbers. In a tenth implementation, process 700 further includes extracting a diagnostic fingerprint of a system failure or warning from a plurality of structured diagnostic records generated across the firmware boot sequence and generating a label for the diagnostic fingerprint that includes a root cause and a fix. In an eleventh implementation, process 700 further includes receiving a diagnosis request that includes a plurality of structured diagnostic records corresponding to an observed system failure; applying a trained machine-learning model to extract the diagnostic fingerprint from those records; identifying a matching diagnostic fingerprint previously labeled with the root cause and the fix; and providing the root cause and the fix in response to the diagnosis request. In a twelfth implementation, the trained machine-learning model includes a graph-based model that captures causal relationships among the plurality of structured diagnostic records.

Although FIG. 7 shows example blocks of process 700, in some implementations the process may include additional blocks, fewer blocks, different blocks, or blocks arranged differently than depicted in FIG. 7. Additionally, two or more of the blocks of process 700 may be performed in parallel.

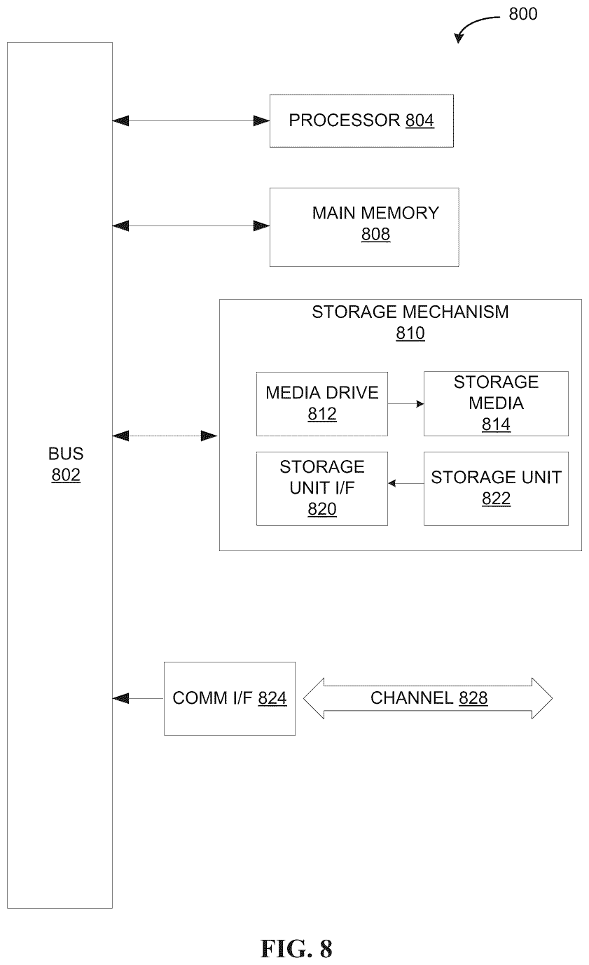

FIG. 8 illustrates an example computing system 800 that may be used in implementing various features of embodiments of the disclosed technology.

As used herein, the term module might describe a given unit of functionality that can be performed in accordance with one or more embodiments of the present application. As used herein, a module might be implemented utilizing any form of hardware, software, or a combination thereof. For example, one or more processors, controllers, ASICs, PLAs, PALS, CPLDs, FPGAs, logical components, software routines or other mechanisms might be implemented to make up a module. In implementation, the various modules described herein might be implemented as discrete modules or the functions and features described can be shared in part or in total among one or more modules. In other words, as would be apparent to one of ordinary skill in the art after reading this description, the various features and functionality described herein may be implemented in any given application and can be implemented in one or more separate or shared modules in various combinations and permutations. Even though various features or elements of functionality may be individually described or claimed as separate modules, one of ordinary skill in the art will understand that these features and functionality can be shared among one or more common software and hardware elements, and such description shall not require or imply that separate hardware or software components are used to implement such features or functionality.

Where components or modules of the application are implemented in whole or in part using software, in one embodiment, these software elements can be implemented to operate with a computing or processing module capable of carrying out the functionality described with respect thereto. One such example computing module is shown in FIG. 8. Various embodiments are described in terms of this example-computing module 800. After reading this description, it will become apparent to a person skilled in the relevant art how to implement the application using other computing modules or architectures.

Referring now to FIG. 8, computing module 800 may represent, for example, computing or processing capabilities found within desktop, laptop, notebook, tablet, cloud and edge, computers; hand-held computing devices (tablets, PDA's, smart phones, cell phones, palmtops, etc.); mainframes, supercomputers, workstations or servers; or any other type of special-purpose or general-purpose computing devices as may be desirable or appropriate for a given application or environment. Computing module 800 might also represent computing capabilities embedded within or otherwise available to a given device. For example, a computing module might be found in other electronic devices such as, for example, digital cameras, navigation systems, cellular telephones, portable computing devices, modems, routers, WAPs, terminals and other electronic devices that might include some form of processing capability.

Computing module 800 might include, for example, one or more processors, controllers, control modules, or other processing devices, such as a processor 804. Processor 804 might be implemented using a general-purpose or special-purpose processing engine such as, for example, a microprocessor, controller, or other control logic. In the illustrated example, processor 804 is connected to a bus 802, although any communication medium can be used to facilitate interaction with other components of computing module 800 or to communicate externally. The bus 802 may also be connected to other components such as a display, input devices, or cursor control to help facilitate interaction and communications between the processor and/or other components of the computing module 800.

Computing module 800 might also include one or more memory modules, simply referred to herein as main memory 808. For example, preferably random-access memory (RAM) or other dynamic memory might be used for storing information and instructions to be executed by processor 804. Main memory 808 might also be used for storing temporary variables or other intermediate information during execution of instructions to be executed by processor 804. Computing module 800 might likewise include a read only memory (“ROM”) or other static storage device 810 coupled to bus 802 for storing static information and instructions for processor 804.

Computing module 800 might also include one or more various forms of information storage devices 810, which might include, for example, a media drive 812 and a storage unit interface 820. The media drive 812 might include a drive or other mechanism to support fixed or removable storage media 814. For example, a hard disk drive, a floppy disk drive, a magnetic tape drive, an optical disk drive, a CD, DVD or Bluray drive (R or RW), or other removable or fixed media drive 812 might be provided. Accordingly, storage media 814 might include, for example, a hard disk, a floppy disk, magnetic tape, cartridge, optical disk, a CD or DVD, or other fixed or removable medium that is read by, written to or accessed by media drive 812. As these examples illustrate, the storage media 814 can include a computer usable storage medium having stored therein computer software or data.

In alternative embodiments, information storage devices 810 might include other similar instrumentalities for allowing computer programs or other instructions or data to be loaded into computing module 800. Such instrumentalities might include, for example, a fixed or removable storage unit 822 and a storage unit interface 820. Examples of such storage units and storage unit interfaces can include a program cartridge and cartridge interface, a removable memory (for example, a flash memory or other removable memory module) and memory slot, a PCMCIA slot and card, and other fixed or removable storage units and interfaces that allow software and data to be transferred from the storage unit to computing module 800.

Computing module 800 might also include a communications interface 824 or network interface(s). Communications or network interface(s) interface 824 might be used to allow software and data to be transferred between computing module 800 and external devices. Examples of communications interface or network interface(s) might include a modem or soft modem, a network interface (such as an Ethernet, network interface card, WiMedia, WiFi, IEEE 802.XX or other interface), a communications port (such as for example, a USB port, IR port, RS232 port Bluetooth® interface, or other port), or other communications interface. Software and data transferred via communications or network interface(s) might typically be carried on signals, which can be electronic, electromagnetic (which includes optical) or other signals capable of being exchanged by a given communications interface. These signals might be provided to communications interface via a channel 828. This channel might carry signals and might be implemented using a wired or wireless communication medium. Some examples of a channel might include a phone line, a cellular link, an RF link, an optical link, a network interface, a local or wide area network, and other wired or wireless communications channels.

In this document, the terms “computer program medium” and “computer usable medium” are used to generally refer to transitory or non-transitory media such as, for example, memory 808, ROM, and storage unit interface 820. These and other various forms of computer program media or computer usable media may be involved in carrying one or more sequences of one or more instructions to a processing device for execution. Such instructions embodied on the medium, are generally referred to as “computer program code” or a “computer program product” (which may be grouped in the form of computer programs or other groupings). When executed, such instructions might enable the computing module 800 to perform features or functions of the present application as discussed herein.

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Each process, method, and algorithm described in the preceding sections may be embodied in, and fully or partially automated by, code modules executed by one or more computer systems or computer processors comprising computer hardware. The processes and algorithms may be implemented partially or wholly in application-specific circuitry.

When the functions disclosed herein are implemented in the form of software functional units and sold or used as independent products, they can be stored in a processor executable non-volatile computer readable storage medium. Particular technical solutions disclosed herein (in whole or in part) or aspects that contribute to current technologies may be embodied in the form of a software product. The software product may be stored in a storage medium, comprising a number of instructions to cause a computing device (which may be a personal computer, a server, a network device, and the like) to execute all or some steps of the methods of the embodiments of the present application. The storage medium may comprise a flash drive, a portable hard drive, ROM, RAM, a magnetic disk, an optical disc, another medium operable to store program code, or any combination thereof.

Particular embodiments further provide a system comprising a processor and a non-transitory computer-readable storage medium storing instructions executable by the processor to cause the system to perform operations corresponding to steps in any method of the embodiments disclosed above. Particular embodiments further provide a non-transitory computer-readable storage medium configured with instructions executable by one or more processors to cause the one or more processors to perform operations corresponding to steps in any method of the embodiments disclosed above.

Embodiments disclosed herein may be implemented through a cloud platform, a server or a server group (hereinafter collectively the “service system”) that interacts with a client. The client may be a terminal device, or a client registered by a user at a platform, wherein the terminal device may be a mobile terminal, a personal computer (PC), and any device that may be installed with a platform application program.

The various features and processes described above may be used independently of one another or may be combined in various ways. All possible combinations and sub-combinations are intended to fall within the scope of this disclosure. In addition, certain method or process blocks may be omitted in some implementations. The methods and processes described herein are also not limited to any particular sequence, and the blocks or states relating thereto can be performed in other sequences that are appropriate. For example, described blocks or states may be performed in an order other than that specifically disclosed, or multiple blocks or states may be combined in a single block or state. The example blocks or states may be performed in serial, in parallel, or in some other manner. Blocks or states may be added to or removed from the disclosed example embodiments. The exemplary systems and components described herein may be configured differently than described. For example, elements may be added to, removed from, or rearranged compared to the disclosed example embodiments.

The various operations of exemplary methods described herein may be performed, at least partially, by an algorithm. The algorithm may be comprised in program codes or instructions stored in a memory (e.g., a non-transitory computer-readable storage medium described above). Such an algorithm may comprise a machine learning algorithm. In some embodiments, a machine learning algorithm may not explicitly program computers to perform a function but can learn from training data to make a prediction model that performs the function.

The various operations of exemplary methods described herein may be performed, at least partially, by one or more processors that are temporarily configured (e.g., by software) or permanently configured to perform the relevant operations. Whether temporarily or permanently configured, such processors may constitute processor-implemented engines that operate to perform one or more operations or functions described herein.

Similarly, the methods described herein may be at least partially processor-implemented, with a particular processor or processors being an example of hardware. For example, at least some of the operations of a method may be performed by one or more processors or processor-implemented engines. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)).

The performance of certain of the operations may be distributed among the processors, not only residing within a single machine, but deployed across a number of machines. In some example embodiments, the processors or processor-implemented engines may be located in a single geographic location (e.g., within a home environment, an office environment, or a server farm). In other example embodiments, the processors or processor-implemented engines may be distributed across a number of geographic locations.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the subject matter has been described with reference to specific example embodiments, various modifications and changes may be made to these embodiments without departing from the broader scope of embodiments of the present disclosure. Such embodiments of the subject matter may be referred to herein, individually or collectively, by the term “invention” merely for convenience and without intending to voluntarily limit the scope of this application to any single disclosure or concept if more than one is, in fact, disclosed.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

Any process descriptions, elements, or blocks in the flow diagrams described herein and/or depicted in the attached figures should be understood as potentially representing modules, segments, or portions of code which include one or more executable instructions for implementing specific logical functions or steps in the process. Alternate implementations are included within the scope of the embodiments described herein in which elements or functions may be deleted, executed out of order from that shown or discussed, including substantially concurrently or in reverse order, depending on the functionality involved, as would be understood by those skilled in the art.

As used herein, “or” is inclusive and not exclusive, unless expressly indicated otherwise or indicated otherwise by context. Therefore, herein, “A, B, or C” means “A, B, C, A and B, A and C, B and C, or A, B, and C,” unless expressly indicated otherwise or indicated otherwise by context. Moreover, “and” is both joint and several, unless expressly indicated otherwise or indicated otherwise by context. Therefore, herein, “A and B” means “A and B, jointly or severally,” unless expressly indicated otherwise or indicated otherwise by context. Moreover, plural instances may be provided for resources, operations, or structures described herein as a single instance. Additionally, boundaries between various resources, operations, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

The term “include” or “comprise” is used to indicate the existence of the subsequently declared features, but it does not exclude the addition of other features. Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

What is claimed is:

1. A computer-implemented method executed by firmware of a computing system, comprising:
redirecting, at a build time of a firmware image, diagnostic headers and diagnostic libraries referenced by firmware modules of the firmware image from default diagnostic libraries to an enhanced diagnostic library that exposes an enhanced diagnostic function;
receiving, during a firmware boot sequence of the computing system, a diagnostic invocation from one of the firmware modules via a diagnostic macro;
expanding, at compile time of the firmware image, the diagnostic macro to call the enhanced diagnostic function that injects a source-line identifier and a monotonic per-call-site counter;
generating, using the expanded diagnostic macro, a structured diagnostic record that comprises at least the source-line identifier and the monotonic per-call-site counter followed by diagnostic information; and
emitting the structured diagnostic record through an output interface selected according to a boot phase of the firmware boot sequence.

2. The method of claim 1, wherein the firmware boot sequence comprises a plurality of boot phases including at least an initialization phase, a driver-execution (DXE) phase, and a runtime phase.

3. The method of claim 2, wherein the emitting the structured diagnostic record through the output interface comprises:
in the initialization phase, appending the structured diagnostic record to a temporary buffer associated with a processor of the computing system; and
deferring transmission of the structured diagnostic record until a later boot phase in which stable memory or I/O resources are available.

4. The method of claim 2, wherein the emitting the structured diagnostic record through the output interface comprises:
in the DXE phase, transmitting the structured diagnostic record to an external debugging environment over at least one of a serial interface, a console output, or a debug-port interface.

5. The method of claim 2, wherein the emitting the structured diagnostic record through the output interface comprises:
in the runtime phase after the computing system has enabled virtual addressing, updating internal pointers of the enhanced diagnostic function using the virtual addressing so that the structured diagnostic record is transmitted through a runtime-safe output interface without interruption.

6. The method of claim 2, wherein the initialization phase, the DXE phase, and the runtime phase generate a plurality of the structured diagnostic records, which are preserved collectively form a continuous diagnostic stream across the firmware boot sequence.

7. The method of claim 1, wherein the redirecting at the firmware image build time comprises:
overriding the diagnostic headers and the diagnostic libraries from multiple different diagnostic library families with the enhanced diagnostic library,
wherein a first subset of the firmware modules are configured to reference a first diagnostic library family and a second subset of the firmware modules are configured to reference a second diagnostic library family, and
wherein the overriding ensures that diagnostic invocations in both the first subset and the second subset of firmware modules are routed to the enhanced diagnostic function.

8. The method of claim 7, wherein the enhanced diagnostic library exposes entry points compatible with both the first and second diagnostic library families and forwards the diagnostic invocations to the enhanced diagnostic function so that a plurality of the structured diagnostic records are produced consistently across different firmware modules.

9. The method of claim 1, wherein the generating the structured diagnostic record using the expanded diagnostic macro comprises:
formatting the structured diagnostic record based on a measurement of available stack space, the formatting comprises:
computing a stack pressure level from the measurement of the available stack space; and
dynamically switching a record format to optimize cache usage.

10. The method of claim 1, further comprising:
providing the structured diagnostic record to an integrated development environment (IDE) running on a developer host, the IDE configured to:
parse a plurality of the structured diagnostic records; and
hyperlink the plurality of the structured diagnostic records to corresponding source files and line numbers.

11. The method of claim 1, further comprising:
extracting a diagnostic fingerprint of a system failure or warning from a plurality of the structured diagnostic records generated across the firmware boot sequence; and
generating a label for the diagnostic fingerprint comprising a root cause and a fix.

12. The method of claim 11, further comprising:
receiving a diagnosis request comprising a plurality of structured diagnostic records corresponding to an observed system failure;
applying a trained machine learning model to extract the diagnostic fingerprint from the plurality of structured diagnostic records corresponding to the observed system failure;
identifying a matching diagnostic fingerprint previously labeled with the root cause and the fix; and
providing the root cause and the fix in response to the diagnosis request.

13. The method of claim 12, wherein the trained machine learning model comprises a graph-based model that captures causal relationships among the plurality of structured diagnostic records.

14. A computing system comprising at least one processor and memory storing firmware instructions that, when executed by the processor, cause the computing system to:
redirect, at firmware image build time, diagnostic headers and diagnostic libraries referenced by firmware modules from default diagnostic libraries to an enhanced diagnostic library that exposes an enhanced diagnostic function;
receive, during a firmware boot sequence of the computing system, a diagnostic invocation from one of the firmware modules via a diagnostic macro;
expand, at compile time of the firmware image, the diagnostic macro to call the enhanced diagnostic function that injects a source-line identifier and a monotonic per-call-site counter;
generate, using the expanded diagnostic macro, a structured diagnostic record that comprises at least the source-line identifier and the monotonic per-call-site counter followed by diagnostic information; and
emit the structured diagnostic record through an output interface selected according to a boot phase of the firmware boot sequence.

15. The computing system of claim 14, wherein the firmware boot sequence comprises a plurality of boot phases including at least an initialization phase, a driver-execution phase, and a runtime phase.

16. The computing system of claim 15, wherein a plurality of the structured diagnostic records generated in the initialization phase, the driver-execution phase, and the runtime phase are preserved and made available together so that the plurality of structured diagnostic records collectively form a continuous diagnostic stream across the firmware boot sequence.

17. The computing system of claim 14, wherein to redirect the diagnostic headers and the diagnostic libraries at the firmware image build time, the computing system is further configured to:
override the diagnostic headers and the diagnostic libraries from multiple different diagnostic library families with the enhanced diagnostic library,
wherein a first subset of the firmware modules are configured to reference a first diagnostic library family and a second subset of the firmware modules are configured to reference a second diagnostic library family, and
wherein the overriding ensures that diagnostic invocations in all firmware modules are routed to the enhanced diagnostic function.

18. A non-transitory computer-readable storage medium storing firmware instructions which, when executed by at least one processor of a computing system, cause the computing system to perform operations comprising:
redirecting, at firmware image build time, diagnostic headers and diagnostic libraries referenced by modules from default diagnostic libraries to an enhanced diagnostic library that exposes an enhanced diagnostic function;
receiving, during a firmware boot sequence of the computing system, a diagnostic invocation from a firmware module via a diagnostic macro;
expanding, at compile time of the firmware image, the diagnostic macro to call the enhanced diagnostic function that injects a source-line identifier and a monotonic per-call-site counter;
generating, using the expanded diagnostic macro, a structured diagnostic record that comprises at least the source-line identifier and the monotonic per-call-site counter followed by diagnostic information; and
emitting the structured diagnostic record through an output interface selected according to a boot phase of the firmware boot sequence.

19. The non-transitory computer-readable storage medium of claim 18, wherein the generating the structured diagnostic record using the expanded diagnostic macro comprises:
formatting the structured diagnostic record based on a measurement of available stack space, the formatting comprises:
computing a stack pressure level from the measurement of the available stack space; and
dynamically switching a record format to reduce cache usage when the stack pressure level exceeds a threshold.

20. The non-transitory computer-readable storage medium of claim 18, the operations further comprising:
providing the structured diagnostic record to an integrated development environment (IDE) running on a developer host, the IDE configured to:
parse a plurality of the structured diagnostic records; and
hyperlink the plurality of the structured diagnostic records to corresponding source files and line numbers.
